(19) United States
(12) Patent Application Publication
(10) Pub. No.: US 2025/0290667 A1
(43) Pub. Date: Sep. 18, 2025

(54) EXTROL TANK CATCHING DEVICE

(71) Applicant: Peter Forcier, Swanzey, NH (US)

(72) Inventor: Peter Forcier, Swanzey, NH (US)

(21) Appl. No.: 19/054,980

(22) Filed: Feb. 17, 2025

Related U.S. Application Data
(60) Provisional application No. 63/565,584, filed on Mar. 15, 2024.

(51) Int. Cl. F24H 9/00; B65G 7/12

(52) U.S. Cl. CPC F24H 9/0094; B65G 7/12

(57) ABSTRACT

An extrol tank catching device is disclosed, which is a tool designed for the safe removal of a #30 extrol tank. The extrol tank catching device comprises a body component that is configured in a basket-like shape and which is sized and shaped to accept a #30 extrol tank. Specifically, the body component is a cylindrical, reinforced mesh body with two nylon straps on top, each equipped with metal pinch adjusters for adjustment of the straps. Further, there are two large metal hooks that attach to the horizontal heating pipe above the #30 tank. Thus, the device's basket-like shape facilitates the safe and secure capture of the heavy #30 tank once it is unscrewed, ensuring it drops safely into the body component during replacement or maintenance of the tanks.

### CROSS-REFERENCE TO RELATED APPLICATION

The present application claims priority to, and the benefit of, U.S. Provisional Application No. 63/565,584, which was filed on Mar. 15, 2024, and is incorporated herein by reference in its entirety.

### FIELD OF THE INVENTION

The present invention relates generally to the field of extrol tank catching devices. More specifically, the present invention relates to a tool designed to catch a hydronic heating system extrol tank when it needs to be replaced. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in extrol tank catching devices. Generally, hydronic heating systems feature a #30 or #60 expansion tank full of water that must be replaced periodically. Typically, each tank weighs 35 to 56 lbs. and is mounted on the supply heating pipe near the ceiling, above the boiler. These tanks are heavy and full of dirty water which makes them difficult to access and replace. Accidents can occur when unscrewing the tank and trying to catch it with their hands.

Generally, a thermal expansion tank is a small, often cylindrical, tank installed in fluid communication with a hot water heater or boiler system and configured to relieve excessive pressure caused by increased temperatures of heated water. An expansion tank is mounted in close proximity to the water heating reservoir it is intended to protect and, in industrial settings, is often mounted in an elevated position above the floor. Specifically, the expansion tank may be coupled below an overhead pipe to which it may be operatively connected that is in fluid communication with the hot water tank.

Further, a plumber or homeowner may be called upon to remove or replace an expansion tank. This task may create a dangerous situation in that disconnecting and dismounting the expansion tank from its elevated position, might cause the expansion tank to free fall to the floor and potentially damage property or injure the worker. Further, an expansion tank may weigh 35 to 56 pounds and be difficult for an unassisted worker to manage, especially considering the elevated position of the tank which may be mounted above the boiler and electronic controls.

Therefore, it would be desirable to have an expansion tank device that can be mounted to an overhead pipe or other elevated frame structure adjacent the expansion device, to eliminate the risk of the expansion tank falling to the floor when disconnected. Further, it would be desirable to have an expansion tank device that is positionally adjustable to surround an expansion tank and to lower a captured tank toward the floor, thus eliminating the risk of damage and injury that may be caused from the expansion device falling to the floor.

Therefore, there exists a long felt need in the art for an extrol tank catching device that provides users with a tool designed to catch a hydronic heating system extrol tank when it needs to be replaced. There is also a long felt need in the art for an extrol tank catching device that features two nylon straps that support a reinforced mesh body. Further, there is a long felt need in the art for an extrol tank catching device that also utilizes two metal hooks that support the device over an extrol tank. Moreover, there is a long felt need in the art for a device that allows the extrol tank to be removed and for it to drop down safely into the mesh body for removal and transportation. Further, there is a long felt need in the art for an extrol tank catching device that eliminates the need to try and catch the tank by hand during removal, improving workplace safety and efficiency. Finally, there is a long felt need in the art for an extrol tank catching device that includes two metal pinch adjusters for adjustment on the nylon straps.

The subject matter disclosed and claimed herein, in one embodiment thereof, comprises an extrol tank catching device. The device is a tool designed for the safe removal of a #30 extrol tank. The extrol tank catching device comprises a body component that is configured in a basket-like shape and which is sized and shaped to accept a #30 extrol tank. Specifically, the body component is a cylindrical, reinforced mesh body with two nylon straps on top, each equipped with metal pinch adjusters for adjustment of the straps. Further, there are two large metal hooks that attach to the horizontal heating pipe above the #30 tank. Thus, the device's basket-like shape facilitates the safe and secure capture of the heavy #30 tank once it is unscrewed, ensuring it drops safely into the body component during replacement or maintenance of the tanks.

In this manner, the extrol tank catching device of the present invention accomplishes all of the forgoing objectives and provides users with a device that facilitates the safe and secure capture of heavy #30 tanks during replacement or maintenance. The device is a basket-like shaped body component with adjustable straps and hooks for hanging from the heating pipe. The device is constructed using durable nylon and metal materials.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an extrol tank catching device. The device is a tool designed for the safe removal of a #30 extrol tank. The extrol tank catching device comprises a body component that is configured in a basket-like shape and which is sized and shaped to accept a #30 extrol tank. Further, there are two large metal hooks that attach to the horizontal heating pipe above the #30 tank. Thus, the device's basket-like shape facilitates the safe and secure capture of the heavy #30 tank once it is unscrewed, ensuring it drops safely into the body component during replacement or maintenance of the tanks.

In one embodiment, the extrol tank catching device for use in extracting a thermal expansion tank according to the present invention is disclosed. The device eliminates the need to try and catch the extrol tank by hand during removal, improving workplace safety and efficiency. Thus, the extrol tank catching device allows the extrol tank to be removed and for it to drop down safely into the mesh body for removal and transportation.

In one embodiment, the extrol tank catching device comprises a body component that is configured in a basket-like shape to facilitate the safe and secure capture of the heavy #30 tank once it is unscrewed. Specifically, the body component is a cylindrical, reinforced mesh body. Further, the body component has a closed bottom surface and an upstanding, curved side wall that together define an open interior area configured to selectively receive an extrol tank. Further, the closed bottom surface includes a curved side wall structure extending upwardly from a peripheral edge or edges of the bottom surface. Together, the bottom surface and curved side wall define an interior area of suitable dimension to receive an extrol tank. Further, upper edges of the curved side wall define an open top in communication with the interior area and that provides access to the interior area. Preferably, the upstanding wall structure is a continuous curved side wall having a generally cylindrical configuration although a body component having a square or rectangular configuration would also function. Specifically, the body component can be any suitable size and shape as is known in the art, as long as the body component is sized and shaped to accept a #30 extrol tank during use.

In one embodiment, the material used for constructing the body component is nylon mesh, canvas, or other durable material suitable for commercial utility applications, or combinations thereof.

In one embodiment, the body component comprises two nylon straps secured on top. Specifically, a pair of support straps are coupled to opposing sides of the curved side wall and extend upward during use. Preferably, the pair of straps are coupled to opposite sides of the curved side wall. In use, the pair of support straps are configured to suspend the body component from an overhead pipe or other frame structure to which an extrol tank is mounted. Typically, upper ends of the support straps (i.e., a first end) include hooks that engage the overhead fluid pipe to which the extrol tank is coupled to. Further, the support straps are length adjustable, such that the body component may be selectively lowered from the hooks when the support straps are operatively lengthened. In one embodiment, each support strap is approximately 16 inches long, such that it can facilitate lowering the body component downwardly from a considerable height above a floor surface.

In one embodiment, the pair of nylon straps are each equipped with metal pinch adjusters for adjustment of the support straps. Specifically, the metal pinch adjuster is secured to an opposing second end of the support straps. The metal pinch adjusters are configured to move the body component closer to or farther from the hooks, as needed. Further, the metal pinch adjusters comprise an intake opening which is configured to receive a second end of a strap and the metal pinch adjusters are then secured to the body component via a small stabilizing strap. The opposing first end of the strap is then secured to a hook for attachment to the horizontal heating pipe. The strap is threaded through the metal pinch adjuster in order for the body component to move upwardly toward the hooks and overhead pipe. Thus, the support straps are length adjustable, allowing a user to raise and lower the body component as needed. Once in position, under the extrol tank, the metal pinch adjuster can be locked into place via a lock member. The body component remains locked in place, until a user wishes to release the lock member and lower the body component to the floor. The lock member of the metal pinch adjuster holds the body component steady until it needs to be lowered. For example, the body component can be selectively lowered from the hooks when the metal pinch adjusters are actuated, to operatively lengthen the support straps. Typically, the metal pinch adjuster includes a release member that is configured to reverse the direction of movement of the strap, to lower the body component downward toward the floor. Thus, the metal pinch adjuster enables a user to control a descending movement of the body component from an elevated position toward the floor. In one embodiment, the metal pinch adjusters can be any suitable means for adjusting the straps as is known in the art.

In one embodiment, the nylon straps have two large metal hooks that attach to the horizontal heating pipe above the #30 tank. Specifically, the first end of the straps include the hooks that are selectively coupled to the overhead heating pipe, mounting bracket, or other structural framework to which the extrol tank is attached. It is understood that the pipe or other hardware in use with the present invention may be in fluid communication with the extrol tank or just in close proximity therewith. Typically, the hook is a traditional hook, clasp, wire loop, or other suitable fastener. However, in one embodiment, the hook is a carabiner fastener in that once it is attached, it cannot be inadvertently detached. Thus, the carabiner fastener secures the straps to the pipe and prevents harm or damage caused by a falling extrol tank.

In one embodiment, the body component comprises a ¼″ round metal rim sewed into the top to aid a user in carrying the device. Also, a user can carry the device and extrol tank by the hooks on the top.

In use, a user such as a plumber may be called upon to remove or replace an extrol tank from a commercial facility, which can be extremely difficult to do via one person as extrol tanks are often mounted at elevated configurations within an industrial facility. To begin with, the hooks and their respective support straps are coupled to the overhead pipe or other frame structure proximate the extrol tank. The metal pinch adjusters are then utilized to adjust the straps as needed to line up the body component directly underneath the extrol tank. In this manner, the open top and interior area defined by the body component are positioned as directly beneath the extrol tank as possible. This enables the extrol tank to be substantially received into the interior area. The extrol tank may then be uncoupled from the overhead pipe and received into the body component without worry of it falling or causing injury to the worker. Now, a user can lift up from the two hooks that are on the heating pipe above and remove the device and extrol tank. Then the user can go outside to safely drain the #30 extrol tank.

In yet another embodiment, the extrol tank catching device comprises a plurality of indicia.

In yet another embodiment, a method of facilitating the safe and secure capture of a #30 tank once unscrewed is disclosed. The method includes the steps of providing an extrol tank catching device comprising a body component with nylon straps and hooks. The method also comprises adjusting the nylon straps to a length, such that the device can be positioned right underneath an extrol tank. Further, the method comprises securing the hooks on the straps around a horizontal heating pipe. The method also comprises unscrewing the extrol tank and lowering the tank into the hanging body component. Finally, the method comprises adjusting the straps, such that body component and extrol tank can be safely lowered to the ground for maintenance or replacement.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the extrol tank catching device of the present invention in accordance with the disclosed architecture;

FIG. 2 illustrates a perspective view of one embodiment of the extrol tank catching device of the present invention showing the two nylon straps in accordance with the disclosed architecture;

FIG. 3 illustrates a perspective view of one embodiment of the extrol tank catching device of the present invention showing the metal pinch adjusters on the straps in accordance with the disclosed architecture;

FIG. 4 illustrates a perspective view of one embodiment of the extrol tank catching device of the present invention showing the metal hooks in accordance with the disclosed architecture;

FIG. 5 illustrates a perspective view of one embodiment of the extrol tank catching device of the present invention showing the device in use in accordance with the disclosed architecture; and

FIG. 6 illustrates a flowchart showing the method of facilitating the safe and secure capture of a #30 tank once unscrewed in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for an extrol tank catching device that provides users with a tool designed to catch a hydronic heating system extrol tank when it needs to be replaced. There is also a long felt need in the art for an extrol tank catching device that features two nylon straps that support a reinforced mesh body. Further, there is a long felt need in the art for an extrol tank catching device that also utilizes two metal hooks that support the device over an extrol tank. Moreover, there is a long felt need in the art for a device that allows the extrol tank to be removed and for it to drop down safely into the mesh body for removal and transportation. Further, there is a long felt need in the art for an extrol tank catching device that eliminates the need to try and catch the tank by hand during removal, improving workplace safety and efficiency. Finally, there is a long felt need in the art for an extrol tank catching device that includes two metal pinch adjusters for adjustment on the nylon straps.

The present invention, in one exemplary embodiment, is a novel extrol tank catching device. The device is a tool designed for the safe removal of a #30 extrol tank. The extrol tank catching device comprises a body component that is configured in a basket-like shape and which is sized and shaped to accept a #30 extrol tank. Specifically, the body component is a cylindrical, reinforced mesh body with two nylon straps on top, each equipped with metal pinch adjusters for adjustment of the straps. Further, there are two large metal hooks that attach to the horizontal heating pipe above the #30 tank. Thus, the device's basket-like shape facilitates the safe and secure capture of the heavy #30 tank once it is unscrewed, ensuring it drops safely into the body component during replacement or maintenance of the tanks. The present invention also includes a novel method of facilitating the safe and secure capture of a #30 tank once unscrewed. The method includes the steps of providing an extrol tank catching device comprising a body component with nylon straps and hooks. The method also comprises adjusting the nylon straps to a length, such that the device can be positioned right underneath an extrol tank. Further, the method comprises securing the hooks on the straps around a horizontal heating pipe. The method also comprises unscrewing the extrol tank and lowering the tank into the hanging body component. Finally, the method comprises adjusting the straps, such that body component and extrol tank can be safely lowered to the ground for maintenance or replacement.

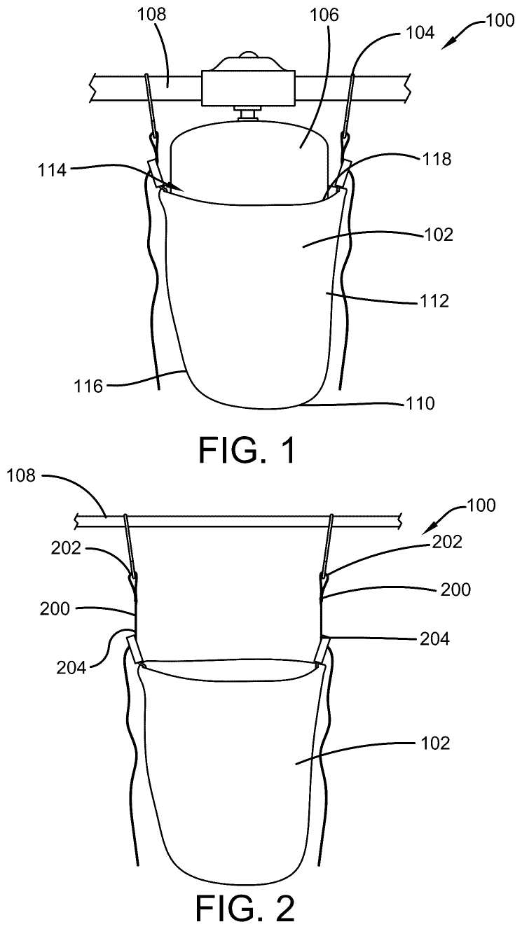

Referring initially to the drawings, FIG. 1 illustrates a perspective view of one embodiment of the extrol tank catching device 100 of the present invention. In the present embodiment, the extrol tank catching device 100 is an improved extrol tank catching device 100 that allows extrol tanks to be removed safely. Specifically, the extrol tank catching device 100 comprises a body component 102 that is configured in a basket-like shape and which is sized and shaped to accept a #30 extrol tank 106. Further, there are two large metal hooks 104 that attach to the horizontal heating pipe 108 above the #30 tank 106. Thus, the device's basket-like shape facilitates the safe and secure capture of the heavy #30 tank 106 once it is unscrewed, ensuring it drops safely into the body component 102 during replacement or maintenance of the tanks 106.

Generally, the extrol tank catching device 100 for use in extracting a thermal expansion tank 106 according to the present invention is disclosed. The device 100 eliminates the need to try and catch the extrol tank 106 by hand during removal, improving workplace safety and efficiency. Thus, the extrol tank catching device 100 allows the extrol tank 106 to be removed and for it to drop down safely into the mesh body component 102 for removal and transportation.

Further, the extrol tank catching device 100 comprises a body component 102 that is configured in a basket-like shape to facilitate the safe and secure capture of the heavy #30 tank 106 once it is unscrewed. Specifically, the body component 102 is a cylindrical, reinforced mesh body. Further, the body component 102 has a closed bottom surface 110 and an upstanding, curved side wall 112 that together define an open interior area 114 configured to selectively receive an extrol tank 106. Further, the closed bottom surface 110 includes a curved side wall structure 112 extending upwardly from a peripheral edge 116 or edges of the bottom surface 110. Together, the bottom surface 110 and curved side wall 112 define an interior area 114 of suitable dimension to receive an extrol tank 106. Further, upper edges 118 of the curved side wall 112 define an open top in communication with the interior area 114 and that provides access to the interior area 114. Preferably, the upstanding wall structure is a continuous curved side wall 112 having a generally cylindrical configuration although a body component 102 having a square or rectangular configuration would also function. Specifically, the body component 102 can be any suitable size and shape as is known in the art, as long as the body component 102 is sized and shaped to accept a #30 extrol tank 106 during use.

Generally, the material used for constructing the body component 102 is nylon mesh, canvas, or other durable material suitable for commercial utility applications, or combinations thereof.

As shown in FIG. 2, the body component 102 comprises two nylon straps 200 secured on top. Specifically, a pair of support straps 200 are coupled to opposing sides of the curved side wall 112 and extend upward during use. Preferably, the pair of straps 200 are coupled to opposite sides of the curved side wall 112. In use, the pair of support straps 200 are configured to suspend the body component 102 from an overhead pipe 108 or other frame structure to which an extrol tank 106 is mounted. Typically, upper ends of the support straps 200 (i.e., a first end 202) include hooks 104 that engage the overhead fluid pipe 108 to which the extrol tank 106 is coupled to. Further, the support straps 200 are length adjustable, such that the body component 102 may be selectively lowered from the hooks 104 when the support straps 200 are operatively lengthened. In one embodiment, each support strap 200 is approximately 16 inches long, such that it can facilitate lowering the body component 102 downwardly from a considerable height above a floor surface.

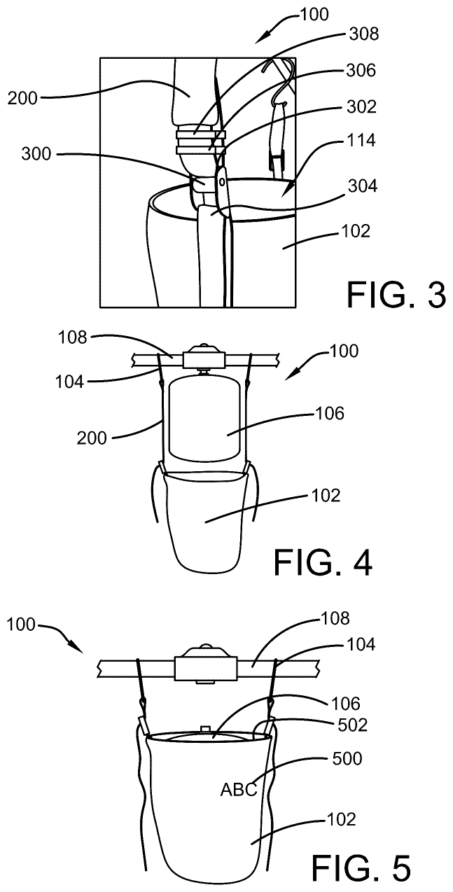

As shown in FIG. 3, the pair of nylon straps 200 are each equipped with metal pinch adjusters 300 for adjustment of the support straps 200. Specifically, the metal pinch adjuster 300 is secured to an opposing second end 204 of the support straps 200. The metal pinch adjusters 300 are configured to move the body component 102 closer to or farther from the hooks 104, as needed. Further, the metal pinch adjusters 300 comprise an intake opening 302 which is configured to receive a second end 204 of a strap 200 and the metal pinch adjusters 300 are then secured to the body component 102 via a small stabilizing strap 304. The opposing first end 202 of the strap 200 is then secured to a hook 104 for attachment to the horizontal heating pipe 108. The strap 200 is threaded through the metal pinch adjuster 300 in order for the body component 102 to move upwardly toward the hooks 104 and overhead pipe 108.

Thus, the support straps 200 are length adjustable, allowing a user to raise and lower the body component 102 as needed. Once in position, under the extrol tank 106, the metal pinch adjuster 300 can be locked into place via a lock member 306. The body component 102 remains locked in place, until a user wishes to release the lock member 306 and lower the body component 102 to the floor. The lock member 306 of the metal pinch adjuster 300 holds the body component 102 steady until it needs to be lowered. For example, the body component 102 can be selectively lowered from the hooks 104 when the metal pinch adjusters 300 are actuated, to operatively lengthen the support straps 200. Typically, the metal pinch adjuster 300 includes a release member 308 that is configured to reverse the direction of movement of the strap 200, to lower the body component 102 downward toward the floor. Thus, the metal pinch adjuster 300 enables a user to control a descending movement of the body component 102 from an elevated position toward the floor. In one embodiment, the metal pinch adjusters 300 can be any suitable means for adjusting the straps 200 as is known in the art.

As shown in FIG. 4, the nylon straps 200 have two large metal hooks 104 that attach to the horizontal heating pipe 108 above the #30 tank 106. Specifically, the first end 202 of the straps 200 include the hooks 104 that are selectively coupled to the overhead heating pipe 108, mounting bracket, or other structural framework to which the extrol tank 106 is attached. It is understood that the pipe 108 or other hardware in use with the present invention may be in fluid communication with the extrol tank 106 or just in close proximity therewith. Typically, the hook 104 is a traditional hook, clasp, wire loop, or other suitable fastener. However, in one embodiment, the hook 104 is a carabiner fastener in that once it is attached, it cannot be inadvertently detached. Thus, the carabiner fastener secures the straps 200 to the pipe 108 and prevents harm or damage caused by a falling extrol tank 106.

As shown in FIG. 5, the extrol tank catching device 100 comprises a plurality of indicia 500. The body component 102 of the device 100 may include advertising, a trademark, or other letters, designs, or characters, printed, painted, stamped, or integrated into the body component 102, or any other indicia 500 as is known in the art. Specifically, any suitable indicia 500 as is known in the art can be included, such as but not limited to, patterns, logos, emblems, images, symbols, designs, letters, words, characters, animals, advertisements, brands, etc., that may or may not be extrol tank, hydronic heating system, or brand related.

In one embodiment, the body component 102 comprises the body component comprises a ¼″ round metal rim 502 sewed into the top to aid a user in carrying the device 100. Also, a user can carry the device 100 and extrol tank 106 by the hooks 104 on the top.

In use, a user such as a plumber may be called upon to remove or replace an extrol tank 106 from a commercial facility, which can be extremely difficult to do via one person as extrol tanks 106 are often mounted at elevated configurations within an industrial facility. To begin with, the hooks 104 and their respective support straps 200 are coupled to the overhead pipe 108 or other frame structure proximate the extrol tank 106. The metal pinch adjusters 300 are then utilized to adjust the straps 200 as needed to line up the body component 102 directly underneath the extrol tank 106. In this manner, the open top and interior area 114 defined by the body component 102 are positioned as directly beneath the extrol tank 106 as possible. This enables the extrol tank 106 to be substantially received into the interior area 114. The extrol tank 106 may then be uncoupled from the overhead pipe 108 and received into the body component 102 without worry of it falling or causing injury to the worker. Then, the metal pinch adjusters 300 can be released and the straps 200 operated to lower the body component 102 to the floor or at least to a lower level, so as to recover the extrol tank 106 safely by the worker.

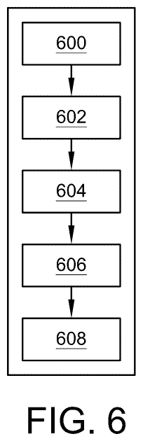

FIG. 6 illustrates a flowchart of the method of facilitating the safe and secure capture of a #30 tank once unscrewed. The method includes the steps of at 600, providing an extrol tank catching device comprising a body component with nylon straps and hooks. The method also comprises at 602, adjusting the nylon straps to a length, such that the device can be positioned right underneath an extrol tank. Further, the method comprises at 604, securing the hooks on the straps around a horizontal heating pipe. The method also comprises at 606, unscrewing the extrol tank and lowering the tank into the hanging body component. Finally, the method comprises at 608, adjusting the straps, such that body component and extrol tank can be safely lowered to the ground for maintenance or replacement.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “extrol tank catching device”, “extrol tank device”, “catching device”, and “device” are interchangeable and refer to the extrol tank catching device 100 of the present invention.

Notwithstanding the forgoing, the extrol tank catching device 100 of the present invention can be of any suitable size and configuration as is known in the art without affecting the overall concept of the invention, provided that it accomplishes the above stated objectives. One of ordinary skill in the art will appreciate that the extrol tank catching device 100 as shown in FIGS. 1-6 is for illustrative purposes only, and that many other sizes and shapes of the extrol tank catching device 100 are well within the scope of the present disclosure. Although the dimensions of the extrol tank catching device 100 are important design parameters for user convenience, the extrol tank catching device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An extrol tank catching device that allows extrol tanks to be removed safely, the extrol tank catching device comprising:
a body component;
a pair of straps; and
two hooks;
wherein the pair of straps are secured to opposing sides of the body component;
wherein at least one of the two hooks is secured to each of the pair of straps;
wherein the two hooks are secured to a horizontal heating pipe which has an extrol tank coupled to it; and
further wherein the body component is positioned below the extrol tank to facilitate safe and secure capture of the extrol tank once it is unscrewed, ensuring it drops safely into the body component during replacement or maintenance of the extrol tank.

2. The extrol tank catching device of claim 1, wherein the body component is configured in a basket-like shape.

3. The extrol tank catching device of claim 2, wherein the body component has a closed bottom surface and an upstanding, curved side wall that together define an open interior area configured to selectively receive an extrol tank.

4. The extrol tank catching device of claim 3, wherein the body component is manufactured of a nylon mesh.

5. The extrol tank catching device of claim 4, wherein the pair of straps are coupled to opposing sides of the curved side wall and extend upward during use, to suspend the body component from a horizontal heating pipe.

6. The extrol tank catching device of claim 5, wherein the pair of straps comprises a first end and an opposing second end, wherein the first end is secured to one of the two hooks which engage the horizontal heating pipe.

7. The extrol tank catching device of claim 6, wherein the pair of straps are each equipped with metal pinch adjusters for length adjustment of the pair of straps.

8. The extrol tank catching device of claim 7, wherein the metal pinch adjuster comprises an intake opening which is configured to receive the second end of the pair of straps.

9. The extrol tank catching device of claim 8, wherein the strap is threaded through the metal pinch adjuster allowing a user to raise and lower the body component as needed.

10. The extrol tank catching device of claim 9, wherein once in position, under the extrol tank, the metal pinch adjuster can be locked into place via a lock member.

11. The extrol tank catching device of claim 10, wherein the metal pinch adjuster includes a release member that is configured to reverse direction of movement of the pair of straps to lower the body component downward toward a floor surface.

12. An extrol tank catching device that allows extrol tanks to be removed safely, the extrol tank catching device comprising:
a body component having a closed bottom surface and an upstanding, curved side wall that together define an open interior area configured to selectively receive an extrol tank;
a pair of straps coupled to opposing sides of the curved side wall and extend upward during use, to suspend the body component from a horizontal heating pipe; and
two hooks; and
wherein the pair of straps comprises a first end and an opposing second end, wherein the first end is secured to one of the two hooks which engage the horizontal heating pipe;
wherein the pair of straps are each equipped with metal pinch adjusters for length adjustment of the pair of straps;
wherein the two hooks are secured to a horizontal heating pipe which has an extrol tank coupled to it; and
further wherein the body component is positioned below the extrol tank to facilitate safe and secure capture of the extrol tank once it is unscrewed, ensuring it drops safely into the body component during replacement or maintenance of the extrol tank.

13. The extrol tank catching device of claim 12, wherein the body component is configured in a basket-like shape.

14. The extrol tank catching device of claim 12, wherein the body component is manufactured of a nylon mesh.

15. The extrol tank catching device of claim 12, wherein the metal pinch adjuster comprises an intake opening which is configured to receive the second end of the pair of straps.

16. The extrol tank catching device of claim 12, wherein the strap is threaded through the metal pinch adjuster allowing a user to raise and lower the body component as needed.

17. The extrol tank catching device of claim 12 further comprising a plurality of indicia.

18. The extrol tank catching device of claim 12, wherein the body component comprises a round metal rim at a top.

19. A method of facilitating the safe and secure capture of a #30 tank once unscrewed, the method comprising the following steps:
providing an extrol tank catching device comprising a body component with nylon straps and hooks;
adjusting the nylon straps to a length, such that the device can be positioned right underneath an extrol tank;
securing the hooks on the straps around a horizontal heating pipe;
unscrewing the extrol tank and lowering the tank into the hanging body component; and adjusting the straps, such that body component and extrol tank can be safely lowered to the ground for maintenance or replacement.
